(19) United States
(12) Patent Application Publication
(10) Pub. No.: US 2020/0172070 A1
(43) Pub. Date: Jun. 4, 2020

(54) ELECTROHYDRAULIC BRAKE SYSTEM FOR AN OFF-ROAD VEHICLE

(71) Applicant: WABCO GmbH, Hannover (DE)

(72) Inventors: Michael Haverkamp, Hannover (DE); Dennis Sabelhaus, Hannover (DE); Frank Zielke, Barsinghausen (DE)

(21) Appl. No.: 16/667,997

(22) Filed: Oct. 30, 2019

(30) Foreign Application Priority Data
Dec. 3, 2018 (DE) 10 2018 130 678.4

(51) Int. Cl. B60T 13/14; B60T 13/68

(52) U.S. Cl. CPC B60T 13/141; B60T 13/686

(57) ABSTRACT

An electrohydraulic brake system of an off-road vehicle includes a first hydraulic brake circuit for a first vehicle axle; a second hydraulic brake circuit for at least one second vehicle axle; a respective wheel brake for each vehicle wheel per vehicle axle; an electronic control unit having a brake force distribution function; a brake signal generator; at least one central brake force distribution valve per brake circuit, a signal input of the control unit for registering a braking signal of the brake signal generator; and at least one signal output of the control unit per brake force distribution valve. A brake pressure for applying a hydraulic pressure fluid to the brake cylinders of the wheel brakes on the respective vehicle axles can be fed to the respective brake circuit by the control unit in conjunction with the central brake force distribution valve and the brake signal generator.

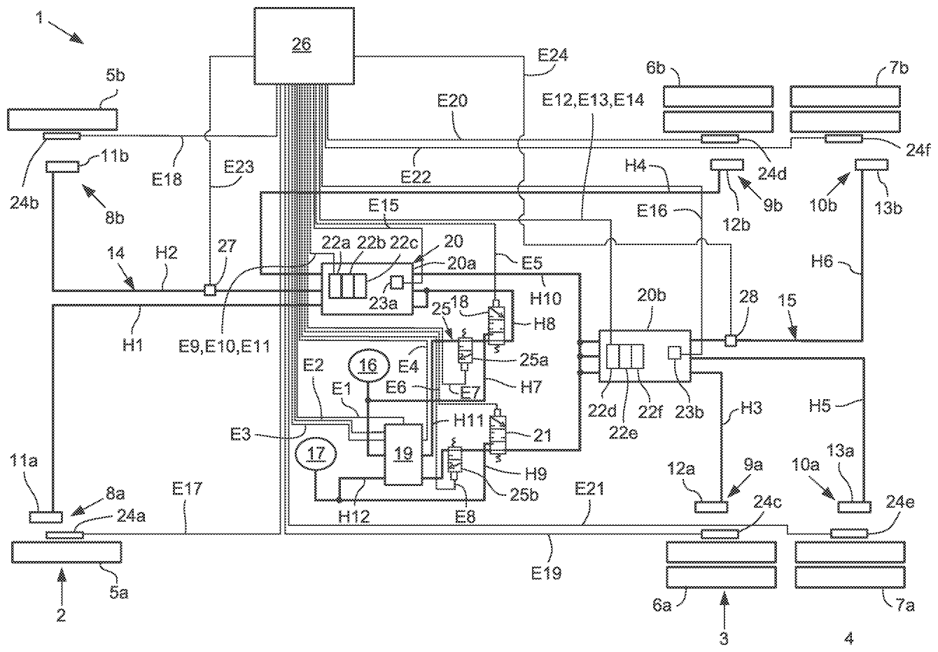

### TECHNICAL FIELD

The invention relates to an electrohydraulic brake system of an off-road vehicle.

### BACKGROUND

In many off-road applications of motor vehicles as such, in which motor vehicles travel on unpaved roadways, electrohydraulic brake systems are used. The hydraulic pressure for the wheel brakes is controlled here by an electrical signal to electromechanical wheel brake valves, wherein the braking request by the driver is registered by a sensor system and transferred to an electronic control unit via a signal generator. The driver thus only influences the functioning of the wheel brakes indirectly, as a result of which largely electronic control of the braking power is possible. In particular, the electronic control permits precise setting of the braking power at each wheel, in order to bring about respectively situation-adapted effective braking of the vehicle.

In the case of electronic brake force distribution, for example the differential slip between the front wheels and the rear wheels or between the front axle and one of the plurality of rear axles of the vehicle is considered. In this context, a brake force distribution function of the electronic control unit controls the brake pressure in the brake cylinders of the wheels of the vehicle axles. This is done by modifying control signals for a valve assembly. Over braking of the rear axle can be prevented, for example, by controlling the braking force between the front and rear axles, before an anti-lock brake system which is possibly present would engage.

Electrohydraulic brake systems for off-road applications are known in various designs. In this context, hydraulic lines are compulsory prescribed between the brake pedal or a brake signal generator and all the wheel brakes and/or their associated brake cylinders. The known electrohydraulic brake systems have, for controlling the braking power, usually for each wheel brake of the vehicle wheels which are to be braked, a proportional valve which can be actuated and whose hydraulic volume flow is monitored during the control process, usually by one respective pressure sensor. This requires considerable expenditure on the necessary components, such as proportional valves and pressure sensors or as well as the associated lines. In addition, the electrical control unit must have a correspondingly large number of interfaces for registering sensor data and for controlling valves. The electronic control unit must correspondingly be of a relatively large, and consequently costly design.

Furthermore different driver assistance systems are increasingly present in vehicles, in particular in utility vehicles such as off-road vehicles, in which the driver assistance systems are able to perform braking interventions autonomously on the vehicle wheels which are to be braked. An anti-lock brake system (ABS) and a startup control system (ATC, English: Automatic Traction Control) or a traction control system (TCS) are frequently already present. Such systems help, specifically on a slippery underlying surface, to prevent vehicle wheels from locking if the service brake is activated too strongly when the vehicle is braked, or to prevent spinning of vehicle wheels if the accelerator pedal is activated too strongly when starting the vehicle.

In addition to an ABS and a startup control or an ATC or a TCS, further driver assistance systems are required, such as for example an electronic stability program (ESP), an adaptive cruise control (ACC) system, a roll stability control (RSC) system or an automatic emergency brake system (AEBS), which are each part of an electronic brake system. In order to control these additional brake systems, an electrohydraulic brake system requires further sensors and valve assemblies as well as additional interfaces which increase the costs for the electronic control unit.

### SUMMARY

Against this background, the invention has been developed with the goals of presenting an electrohydraulic brake system which can satisfy the above-mentioned requirements and which is cost-effective to manufacture. In particular, the number of necessary valves and sensors as well as the expenditure on electronic interfaces for capturing signals and for controlling the components to be controlled is to be as low as possible. Nevertheless, the brake system is to be adaptable in a flexible way to the respective requirements. In particular, such a brake system is to be suitable for use in the drive train of an off-road vehicle.

The stated goals are, at least partially, achieved by an electrohydraulic brake system of an off-road vehicle comprising a first hydraulic brake circuit for a first vehicle axle; a second hydraulic brake circuit for at least one second vehicle axle; at least one wheel brake for in each case one vehicle wheel per vehicle axle, wherein the wheel brake has a brake cylinder to which a hydraulic pressure fluid can be applied; an electronic control unit having a brake force distribution function; at least one brake signal generator; at least one central brake force distribution valve per brake circuit; at least one signal input of the electronic control unit for registering a braking signal of the brake signal generator; and at least one signal output of the electronic control unit per brake force distribution valve for controlling same. The brake system is configured to feed a brake pressure for applying a hydraulic pressure fluid to the brake cylinders of the wheel brakes which are to be braked, on the respective vehicle axles, to the respective brake circuit via the electronic control unit in cooperation with the central brake force distribution valve and the brake signal generator.

In an electrohydraulic brake system according to the invention, accordingly just one hydraulic brake force distribution valve is required per brake circuit for activating the brake. Furthermore, in the simplest case, just one sensor for registering a braking requirement is required for a brake signal generator. An electronic control unit for controlling the brake system accordingly requires just one input for registering the braking requirement and an output for controlling the brake pressure of the vehicle wheels which are to be braked on the front axle as well as just a single further output to one or more rear axles for controlling the brake pressure of the vehicle wheels which are to be braked. As a result, the number of valves and sensors is reduced compared to other technical solutions, which gives rise to a perceptible cost saving. In addition, a reduction in required installation space and weight of the brake system can be achieved.

Furthermore, use can be made of an electronic control unit for pneumatic brake systems customary in utility vehicles or for hydraulic brake systems that are commonplace in passenger cars. Such an electronic control unit can be adapted comparatively easily to an electrohydraulic brake system having the features of the invention using simple modifications. As a result, costs for the re-design of a control unit for an electronic brake system can be eliminated. Taking this minimum equipment level of an electrohydraulic brake system as a starting point, a variety of extensions with driver assistance systems, such as have already been mentioned at the beginning, are possible depending on the requirements.

According to one favorable example of a brake system having the features of the invention, the brake force distribution valves thereof may be embodied as proportional valves.

Accordingly, for example, proportional valves which are embodied as 3/3-way solenoid switching valves can be used, specifically each with two switching positions for two hydraulic connections for acting hydraulically on in each case, one brake circuit, and with a closed position lying between them. Proportional valves have proven suitable in hydraulic systems in many ways. A first switched position of such a 3/3-way solenoid switching valve can open or closed a direct connection between a pressure medium reservoir and a brake force distribution valve. A second switched position can open or close an indirect connection between the pressure medium reservoir via a brake signal generator which evaluates a braking requirement, such as for example a brake pedal travel, and the brake force distribution valve.

According to one example of the invention, at least one of the brake circuits may have a central pressure sensor for monitoring brake pressure and/or for controlling brake pressure, and that the electronic control unit has a signal input for each arranged pressure sensor. Accordingly, such an electrohydraulic brake system permits two control modes. In a first control mode, the brake pressure can be monitored and controlled by one respective pressure sensor per brake circuit. In each case one pressure sensor can be integrated into one of the associated brake lines per brake circuit. As a result a closed-loop control circuit can be provided. This first pressure control mode permits targeted control of the brake pressure within the closed-loop control circuit of the associated brake lines. The control can be carried out by pulsed pressure modulators (by pulse-width modulation) and/or by proportional valves, wherein, for example, per brake circuit one valve serves for building up pressure and maintaining pressure and a further valve or a pressure modulator serves for reducing pressure. As an alternative to this, in a second control mode it is possible to act on the brake circuits hydraulically without internal pressure sensors in an open-loop control circuit.

According to one example of the invention, a wheel speed sensor may be present in the region of each vehicle wheel which is to be braked, and that the electronic control unit has a signal input for each arranged wheel speed sensor. The wheel speed sensors accordingly continuously provide the electronic control unit with measured values relating to the wheel speed of the driven vehicle wheels. These data can be evaluated in the electronic control unit so that the slip can be recorded continuously. The determined values relating to the recording of the slip can be retrieved by a plurality of driver assistance systems and used for brake control and/or drive control of the vehicle with respect to this slip. As a result, these systems favorably do not require a respective separate sensor system for slip detection.

According to another development of the invention, at least one of the brake circuits may have a central temperature sensor for monitoring the temperature of the hydraulic pressure fluid in this brake circuit, and that the electronic control unit has a signal input for each arranged temperature sensor. The determined temperature data can be evaluated in the electronic control unit and can be input via the latter into the control of various driver assistance systems, in order to adapt the braking control where there is a risk of overheating of wheel brakes and counteract overheating. This improves the operational reliability of the electrohydraulic brake system.

Furthermore, the electrohydraulic brake system may have an anti-lock brake system, wherein the anti-lock brake system respectively has an anti-lock brake control valve for each vehicle wheel which is to be braked, which cooperates with the brake force distribution valve of the respective brake circuit to generate an anti-lock braking function, and that the electronic control unit has a signal output for each arranged anti-lock brake control valve for controlling same. According, an anti-brake system can be integrated with relatively low expenditure into an electrohydraulic brake system according to the invention. In particular, such an anti-lock brake system for two brake circuits can be supplied with hydraulic fluid independently of the number of vehicle wheels which are to be braked, and therefore independently of the number of anti-lock brake control valves, via the merely two central brake force distribution valves of the two brake circuits. The actuation of the anti-lock brake control valves is carried out by the electronic control unit, for which a corresponding number of interfaces is provided.

According to one favorable example there is provision that the anti-lock brake control valves of the anti-lock brake control system are embodied as pulse-width-modulated valves, and that the electronic control unit is designed to perform pulse control of these valves. Accordingly, pulse-width-modulated valves or pulse-width-modulated brake pressure modulators for modulating the brake pressure can be used for the anti-lock brake system, where the valves or modulators reduce just one brake pressure while the brake force distribution valves which are present are used for building up the pressure. Software which is possible already implemented in the electronic control unit and which is based on control of pulse-control valves can favorably be used to actuate the pulse-width-modulated anti-brake control valves.

As a result of design of the electrohydraulic brake system according to the invention, on the one hand the total number of proportional valves of the brake system is reduced and, on the other hand, it is favorably possible to use an anti-lock brake system which is based on pulse-modulated control and, for example, is already known from pneumatic brake systems.

According to a further example of the invention the electrohydraulic brake system may have a starter control system which cooperates with the anti-lock brake control system to generate a starter control function. Such a startup system can evaluate the measured wheel speeds of the vehicle wheels and favorably control a traction control system of the vehicle wheels of the front axle or of the vehicle wheels of the one or more rear axles of the off-road vehicle, just as favorably as the anti-lock brake system via the anti-lock brake control valves and the merely two brake force distribution valves of the two brake circuits.

Furthermore, the electrohydraulic brake system may have a hydraulic redundancy brake circuit with two redundancy valves which can be actuated and which are each hydraulically connected to one of the two brake force distribution valves and which are electrically connected to the electronic control unit in such a way that an emergency braking function of the off-road vehicle can be activated in the event of a malfunction of the brake system. Accordingly, by virtue of the redundancy brake circuit, it is possible to ensure a prescribed emergency braking function of the brake system. Only two redundancy valves are necessary for this, which valves are embodied, for example, as 3/2-way solenoid switching valves which are each hydraulically intermediately connected between the brake signal generator and a brake force distribution valve of a brake circuit.

Finally, the invention also relates to an off-road vehicle, such as, for example an agricultural tractor, a construction vehicle, a military vehicle, a special vehicle or a truck, as an individual vehicle or as a tractor vehicle-trailer vehicle combination, having a electrohydraulic brake system which is constructed according to one of the device claims.

The invention is explained in more detail below by way of an example which is illustrated in the appended drawing.

### BRIEF DESCRIPTION OF THE DRAWING

In the drawing, the single figure shows an electrohydraulic plan of a brake system of an off-road vehicle.

### DETAILED DESCRIPTION OF THE DRAWING

In the drawing, the single figure shows an electrohydraulic plan of a brake system 1 of an off-road vehicle. For the sake of improved differentiation, a prefix of “H” is placed in front of all the hydraulic connecting lines, and a prefix “E” is placed in front of all the electrical connecting lines.

Accordingly, the off-road vehicle in the example shown comprises a first vehicle axle 2 which is embodied as a front axle, and two second and third vehicle axles 3, 4 which are embodied as rear axles. In order to brake the front vehicle wheels 5a, 5b and the rear vehicle wheels 6a, 6b and 7a, 7b, each vehicle wheel 5a, 5b, 6a, 6b, 7a, 7b is assigned a wheel brake 8a, 8b, 9a, 9b, 10a, 10b. The wheel brakes 8a, 8b, 9a, 9b, 10a, 10b can be actuated hydraulically and each have a brake cylinder 11a, 11b, 12a, 12b, 13a, 13b. The wheel brakes 8a, 8b, 9a, 9b, 10a, 10b correspondingly apply a braking force, in accordance with the hydraulic pressure which is respectively present in the brake cylinder 11a, 11b, 12a, 12b, 13a, 13b, to the rotating vehicle wheel 5a, 5b, 6a, 6b, 7a, 7b. The brake cylinders 12a, 12b or 13a, 13b of the front vehicle wheels 6a, 6b or 7a, 7b of a rear vehicle axle 3, 4 can additionally be provided with spring mechanisms for a parking brake function.

In the example shown, the wheel brakes 8a, 8b of the front vehicle axle 2 are assigned to a common first hydraulic brake circuit 14, while the wheel brakes 9a, 9b, 10a, 10b or the rear vehicle axles 3, 4 can be actuated by a second hydraulic brake circuit 15. A first pressure reservoir 16 is assigned here to the first brake circuit 14 and is connected via a first hydraulic brake line H1 to the first brake cylinder 11a, and via a second hydraulic brake line H2 to the second brake cylinder 11b of the front first vehicle axle 2. The second brake circuit 15 is assigned a second pressure medium reservoir 17 which is connected via a third hydraulic brake line H3 to the third brake cylinder 12a, and via a fourth hydraulic brake line H4 to the fourth brake cylinder 12b of the rear second vehicle axle 3, and via a fifth hydraulic brake line H5 to the fifth brake cylinder 13a, and via a sixth hydraulic brake line H6 to the sixth brake cylinder 13b of the rear third vehicle axle 4.

In the first brake circuit 14 a first brake force distribution valve 18, which is embodied as a 3/3-way proportional solenoid switching valve is arranged. This first brake force distribution valve 18 is connected via a seventh hydraulic connecting line H7 to a brake signal generator 19, and via an eighth hydraulic connecting line H8 to an input of a first ABS module 20a, assigned to the first brake circuit 14 and to the second brake circuit 15, of an anti-lock brake system 20.

In the second brake circuit 15, a second brake force distribution valve 21, embodied as a 3/3-way proportional switching valve, is arranged. The second brake force distribution valve 21 is connected via a ninth hydraulic connecting line H9 to the brake signal generator 19, and via a tenth hydraulic connecting line H10 to an input of the first ABS module 20a assigned to the first brake circuit 14 and the second brake circuit 15, and to an input of a second ABS module 20b, assigned to the second brake circuit 15, of the anti-brake system 20.

The brake signal generator 19 is coupled to a braking request means, in particular to a brake pedal not illustrated in the driver's cab of the vehicle, wherein pedal travel, a pedal position or the like are transferred via sensor means to the signal generator 19 which makes this data available continuously or for retrieval. The driver of the vehicle can request, by activating the brake pedal, hydraulic brake pressure for acting on the brake cylinders 11a, 11b, 12a, 12b, 13a, 13b.

Each of the two ABS modules 20a, 20b has three anti-lock brake control valves 22a, 22b, 22c, 22d, 22e, 22f which are embodied as pulse-width-modulated valves, wherein each brake cylinder 11a, 11b, 12a, 12b, 13a, 13b of the wheel brakes 8a, 8b, 9a, 9b, 10a, 10b is respectively assigned an anti-lock brake control valve 22a, 22b, 22c, 22d, 22e, 22f for controlling the brake pressure of an anti-lock brake function. In addition, the two ABS modules 20a, 20b each have a temperature sensor 23a, 23b for monitoring the temperature of the hydraulic fluid of the two brake circuits 14, 15. The vehicle wheels 5a, 5b, 6a, 6b, 7a, 7b are each assigned a wheel speed sensor 24a, 24b, 24c, 24d, 24e, 24f for detecting slip and controlling slip via the anti-lock brake system.

Furthermore, the electrohydraulic brake system 1 has a redundancy brake circuit 25 in order to be able to safely brake the vehicle in the event of a fault-induced failure of the brake system 1 or of parts thereof. The redundancy brake circuit 25 has two redundancy valves 25a, 25b which are each embodied as 3/2-way solenoid switching valves. In this context, a first redundancy valve 25a is connected upstream of the first brake circuit 14 and is connected via an eleventh hydraulic connecting line H11 to the brake signal generator 19, on the input side, and to the first brake force distribution valve 18, on the output side. A second redundancy valve 25b is connected upstream of the second brake circuit 15 and is connected via a twelfth hydraulic connecting line H12 to the brake signal generator 19 on the input side, and to the brake force distribution valve 21 on the output side.

The electrohydraulic brake system 1 is controlled by a central electronic control unit 26. The driver of the motor vehicle can, by activating the brake pedal, signal a braking request, but the subsequent braking behavior of the vehicle is influenced by the control unit 26.

The electronic control 26 has a plurality of electrical interfaces. They relate to connections for: four electrical connecting lines E1, E2, E3, E4 to the brake signal generator 19 for two braking requirements sensors and for two braking requirement switches which are assigned to the brake signal generator 19, but are not illustrated further here; two electrical connecting lines E5, E6 to in each case one brake force distribution valve 18, 21; two electrical connecting lines E7, E8 to in each case one redundancy valve 25a, 25b; six electrical connecting lines E9, E10, E11, E12, E13, E14 to in each case one anti-lock brake control valve 22a, 22b, 22c, 22d, 22e, 22f, two electrical connecting lines E15, E16 to in each case one temperature sensor 23a, 23b; and six electrical connecting lines E17, E18, E19, E20, E21, E22, each associated with one respective wheel speed sensor 24a, 24b, 24c, 24d, 24e, 24f.

Furthermore, two further interfaces or electrical connections can be formed for connecting lines E23, E24 on the control unit 26, which interfaces or electrical connections are connected to in each case one pressure sensor 27, 28 per brake circuit 14, 15, in order to implement a pressure control mode with a closed-loop control circuit.

The electronic control unit 26 is for this purpose embodied and configured to act automatically on a braking process in the manner of a “brake-by-wire system”. For this purpose, the control unit 26 determines, on the basis of the information supplied to it, control signals for the brake force distribution valves 18, 21, in order to open them dependent on the brake signal generator 19 in a first switched position, and independently of the brake signal generator 19 in a second switched position, and to apply pressure individually to each of the brake circuits 14, 15. As a result, the braking force is distributed between the front vehicle axle 2 and the rear vehicle axles 3, 4. In the event of a brake control operation by the anti-lock brake function, the anti-lock brake control valves 22a, 22b, 22c, 22d, 22e, 22f are supplied with pulsed control signals. The braking behavior of the individual wheel brakes 8a, 8b, 9a, 9b, 10a, 10b is set with these control signals. In the event of a failure or fault in the electrohydraulic brake system 1, the redundancy valves 25a, 25b disconnect at least the wheel brakes 9a, 9b, 10a, 10b of the rear vehicle axles 3, 4 from the pressure medium supply, as result of which the parking brake is activated by the abovementioned spring mechanism.

### LIST OF REFERENCE SYMBOLS (PART OF THE DESCRIPTION)

1 Electrohydraulic brake system

2 First vehicle axle, front axle

3 Second vehicle axle, rear axle

4 Third vehicle axle, rear axle

5a First vehicle wheel

5b Second vehicle wheel

6a Third vehicle wheel

6b Fourth vehicle wheel

7a Fifth vehicle wheel

7b Sixth vehicle wheel

8a First wheel brake

8b Second wheel brake

9a Third wheel brake

9b Fourth wheel brake

10a Fifth wheel brake

10b Sixth wheel brake

11a First brake cylinder

11b Second brake cylinder

12a Third brake cylinder

12b Fourth brake cylinder

13a Fifth brake cylinder

13b Sixth brake cylinder

14 First hydraulic brake circuit

15 Second hydraulic brake circuit

16 First pressure medium reservoir

17 Second pressure medium reservoir

18 First brake force distribution valve

19 Brake signal generator

20 Anti-lock brake system, ABS

20a First ABS module

20b Second ABS module

21 Second brake force distribution valve

22a First anti-lock brake control valve

22b Second anti-lock brake control valve

22c Third anti-lock brake control valve

22d Fourth anti-lock brake control valve

22e Fifth anti-lock brake control valve

22f Sixth anti-lock brake control valve

23a First temperature sensor

23b Second temperature sensor

24a First wheel speed sensor

24b Second wheel speed sensor

24c Third wheel speed sensor

24d Fourth wheel speed sensor

24e Fifth wheel speed sensor

24f Sixth wheel speed sensor

25 Redundancy brake circuit

25a First redundancy valve

25b Second redundancy valve

26 Electronic control unit

27 Pressure sensor at first hydraulic brake circuit

28 Pressure sensor at second hydraulic brake circuit

E1-E24 First to twenty-fourth electrical connecting lines

H1-H12 First to twelfth hydraulic connecting lines, brake lines

1. An electrohydraulic brake system (1) of an off-road vehicle, comprising:
a first brake circuit (14) associated with a first vehicle axle (2),
a second brake circuit (15) associated with at least one second vehicle axle (3, 4),
at least one respective wheel brake (8a, 8b, 9a, 9b, 10a, 10b) associated with a vehicle wheel (5a, 5b, 6a, 6b, 7a, 7b) for each of the first and second vehicle axles (2, 3, 4), wherein the wheel brake has a brake cylinder (11a, 11b, 12a, 12b, 13a, 13b) configured to be pressurized by a hydraulic pressure fluid,
an electronic control unit (26) having a brake force distribution function,
a brake signal generator (19),
at least one respective central brake force distribution valve (18, 21) for each of the first and second brake circuits (14, 15),
at least one signal input of the electronic control unit (26) for receiving a braking signal of the brake signal generator (19), and
at least one respective signal output of the electronic control unit (26) for each of the at least one brake force distribution valve (18, 21),
wherein the electronic control unit is configured to hydraulically pressurize the brake cylinders (11a, 11b, 12a, 12b, 13a, 13b) of the wheel brakes (8a, 8b, 9a, 9b, 10a, 10b) on respective vehicle axles (2, 3, 4) by directing the hydraulic pressure fluid to at least one of the first and second brake circuits (14, 15) in cooperation with the central brake force distribution valve (18, 21) and the brake signal generator (19).

2. The brake system as claimed in claim 1, wherein the brake force distribution valves (18, 21) are embodied as proportional valves.

3. The brake system as claimed in claim 1, wherein at least one of the first and second brake circuits (14, 15) has a central pressure sensor (27, 28) for monitoring a prevailing brake pressure, and wherein the electronic control unit (26) has a signal input for each of the at least one central pressure sensor (27, 28).

4. The brake system as claimed in claim 1, wherein a respective wheel speed sensor (24a, 24b, 24c, 24d, 24e, 24f) is associated with each vehicle wheel (5a, 5b, 6a, 6b, 7a, 7b), wherein the electronic control unit (26) has a signal input for each respective wheel speed sensor (24a, 24b, 24c, 24d, 24e, 24f).

5. The brake system as claimed in one of claim 1, wherein at least one of the first and second brake circuits (14, 15) has a respective central temperature sensor (23a, 23b) for monitoring the temperature of the hydraulic pressure fluid in the brake circuit (14, 15), and wherein the electronic control unit (26) has a signal input for each respective temperature sensor (23a, 23b).

6. The brake system as claimed in one of claim 1, wherein the electrohydraulic brake system (1) forms an anti-lock brake system (20), wherein the anti-lock brake system (20) has a respective anti-lock brake control valve (22a, 22b, 22c, 22d, 22e, 22f) for each vehicle wheel (5a, 5b, 6a, 6b, 7a, 7b), the respective anti-lock brake control valve cooperating with the brake force distribution valve (18, 21) of the first or second brake circuit (14, 15) to generate an anti-lock braking function, wherein the electronic control unit (26) has a respective signal output for controlling each respective anti-lock brake control valve (22a, 22b, 22c, 22d, 22e, 22f).

7. The brake system as claimed in claim 6, wherein the anti-lock brake control valves (22a, 22b, 22c, 22d, 22e, 22f) of the anti-lock brake control system (20) are embodied as pulse-width-modulated valves, wherein the electronic control unit (26) is configured to perform pulse control of these valves.

8. The brake system as claimed in one of claim 1, wherein the electrohydraulic brake system (1) has a starter control system which cooperates with the anti-lock brake control system (20) to generate a starter control function.

9. The brake system as claimed in one of claim 1, wherein the electrohydraulic brake system (1) has a hydraulic redundancy brake circuit (25) with two redundancy valves (25a, 25b) configured to be actuated and to be hydraulically connected to one of the two brake force distribution valves (18, 21), the two redundancy valves being electrically connected to the electronic control unit (26) and enable the electronic control unit to activate an emergency braking function of the off-road vehicle in the event of a malfunction of the brake system.

10. An off-road vehicle comprising an electrohydraulic brake system (1) according to claim 1.

11. The off-road vehicle as claimed in claim 10, wherein the off-road vehicle is an agricultural tractor, a construction vehicle, a military vehicle, a truck, or a tractor-trailer vehicle combination.
